(19) United States
(12) Patent Application Publication
(10) Pub. No.: US 2004/0118126 A1
(43) Pub. Date: Jun. 24, 2004

(54) Use of a chemical solvent to separate CO2 from a H2S-rich stream

(76) Inventors: James O.Y. Ong, Houston, TX (US); Daniel A. Woodall, Houston, TX (US)

Correspondence Address: Frank C. Turner, Chervon Services Company, Suite 4040, 1111 Bagby Street, Houston, TX, 77002-2543, US

(21) Appl. No.: 10/324,541

(22) Filed: Dec. 19, 2002

(51) Int. Cl. B01D 53/14

(52) U.S. Cl. 60/780; 95/181; 423/228

(57) ABSTRACT

A chemical solvent is utilized to preferentially remove CO₂ from a H₂S-rich acid gas stream, the acid gas stream being absorbed by the chemical solvent from a sour syngas stream. A chemical solvent such as alkanolamine is used in a unique process configuration to separate CO₂ from the acid gas stream. The resulting acid gas is significantly higher in H₂S concentration with a substantial quantity of CO₂ being removed. The resulting CO₂-rich gas is recovered at minimal pressure loss, and can be remixed with the resulting sweet syngas stream as a feed for a gas combustion turbine for increased power generation.

### BACKGROUND OF THE INVENTION

Integrated gasification and power generation systems are used throughout the world to generate power in a combustion turbine using the gasification products of a carbonaceous fuel source. Gasification is commonly used as a means to convert low value hydrocarbons that contain high levels of sulfur, such as coal, coke, and vacuum residue, into clean burning combustion turbine fuel. If these fuels were not gasified prior to being combusted, they would otherwise emit high levels of environmentally harmful gases, such as SOx, NOx and CO₂. Using gasification technology, low value hydrocarbon fuels can achieve emission rates that are comparable to those of natural gas fed combustion turbines.

A raw synthesis gas or syngas fuel gas stream, generally comprising H₂, CO, CO₂, and H₂O, is produced by the partial oxidation reaction, or gasification, of a hydrocarbonaceous fuel with a free-oxygen containing gas, typically in the presence of a temperature moderator, in a quench gasification reactor. The syngas produced is cooled by quenching in water to produce a stream of quenched, saturated syngas at a temperature typically in the range of about 450° F. to 550° F. and at a typical pressure of about 700 to 1500 psig. A more detailed description of one such process appears in U.S. Pat. No. 5,345,756, to Jahnke et al, which is incorporated herein by reference. To make the gasification process more efficient, the process is typically operated at high pressure (1000-1500 psig). At high pressure the gasification process generates waste heat at high temperatures, making the syngas useful as a heat source for steam generation and other applications. Furthermore, the greater the efficiency of the gasification process, the lower the overall emissions because less fuel is required to generate the same amount of power.

When hydrocarbons are gasified, the sulfur in the fuel is converted to H₂S and COS. The syngas is typically purified in an acid gas removal unit employing a physical or chemical solvent to remove H₂S, CO₂, and COS from the gas stream. The purified syngas is then fed as fuel gas to the combustor of a gas turbine with a temperature moderator such as nitrogen. The combustion products are then expanded through a turbine which is attached to a generator to make power, and the waste heat of the combustion products is further used to make steam that in turn generates additional power in a steam turbine.

Removing H₂S from the syngas is relatively easy when using conventional physical and chemical solvents. With physical absorption, CO₂ and H₂S dissolve physically in the solvent. When absorption is complete, pressure is decreased considerably whereupon gaseous components are desorbed into their original state. The physical solvent can then be recycled. Organic solvents of high boiling points, such as polyethylene glycol dimethyl ether (Selexol) or tetrahydrothiophene-1,1-dioxide (Sulfolan) are commonly used as physical absorbants. With chemical absorption, aqueous solutions of various alkanolamine compounds, such as monoethanol amine (MEA), diethanol amine (DEA), diisopropanol amine (DIPA), diglycol amine (DGA), and methyl diethanol amine (MDEA), are utilized to chemically bind the acidic components to be removed in the form of adducts. Solvent regeneration is based on the phenomenon that an increase in temperature and a decrease in pressure decomposes the complex, whereupon the acid gas liberates.

Once the acid gas stream is obtained by physical or chemical absorption, preferentially removing CO₂ from the acid gas stream has several advantages for an IGCC plant, such as enriching the acid gas feed to sulfur recovery facilities (SRU), thereby making the SRU cheaper and easier to operate. The recovered CO₂ can then be sent to the gas combustion turbine for power augmentation. Thus, it would be desirable to provide an efficient method for removing CO₂ from an H₂S-rich acid gas stream, such as acid gas streams separated from syngas.

### SUMMARY OF THE INVENTION

A chemical solvent is utilized to preferentially remove CO₂ from a H₂S-rich acid gas stream, the acid gas stream being absorbed by the chemical solvent from a sour syngas stream. A chemical solvent such as alkanolamine is used in a unique process configuration to separate CO₂ from the acid gas stream. The resulting acid gas is significantly higher in H₂S concentration with a substantial quantity of CO₂ being removed. The resulting CO₂-rich gas is recovered at minimal pressure loss, and can be remixed with the resulting sweet syngas stream as a feed for a gas combustion turbine for increased power generation.

### BRIEF DESCRIPTION OF THE DRAWINGS

FIG. 1 is a simplified process flow diagram illustrating one embodiment of the present invention.

### DESCRIPTION OF ILLUSTRATIVE EMBODIMENTS

The present invention pertains to a novel process for the purification of the products of partial oxidation, or gasification, of a high sulfur containing hydrocarbon feedstock. By definition, gasification reactor, partial oxidation reactor, or gasifier are used interchangeably to describe the reactor in which the partial oxidation of a feedstock takes place, converting the feedstock into synthesis gas, or syngas. Partial oxidation reactors are well known in the art, as are partial oxidation reaction conditions. See, for example, U.S. Pat. Nos. 4,328,006, 4,959,080 and 5,281,243, all incorporated herein by reference.

The feedstock to a gasifier can include pumpable hydrocarbon materials and pumpable slurries of solid carbonaceous materials, and mixtures thereof, for example, pumpable aqueous slurries of solid carbonaceous fuels are suitable feedstocks. In fact, any substantially combustible carbon-containing fluid organic material, or slurries thereof may be used as feed for a gasifier. For example, there are:

(1) pumpable slurries of solid carbonaceous fuels, such as coal, particulate carbon, petroleum coke, concentrated sewer sludge, and mixtures thereof, in a vaporizable liquid carrier, such as water, liquid CO₂, liquid hydrocarbon fuel, and mixtures thereof;

(2) suitable liquid hydrocarbon fuel feedstocks, such as liquefied petroleum gas, petroleum distillates and residua, gasoline, naphtha, kerosine, crude petroleum, asphalt, gas oil, residual oil, tar sand oil and shale oil, coal derived oil, aromatic hydrocarbons (such as benzene, toluene, xylene fractions), coal tar, cycle gas oil from fluid-catalytic-cracking operations, furfural extract of coker gas oil, and mixtures thereof; and

(3) oxygenated hydrocarbonaceous organic materials including carbohydrates, cellulosic materials, aldehydes, organic acids, alcohols, ketones, oxygenated fuel oil, waste liquids and by-products from chemical processes containing oxygenated hydrocarbonaceous organic materials, and mixtures thereof.

Gaseous hydrocarbonaceous fuels may also be burned in the partial oxidation gasifier alone or along with the fluid hydrocarbonaceous fuel includes vaporized liquid natural gas, refinery off-gas, C₁-C₄ hydrocarbonaceous gases, and waste carbon-containing gases from chemical processes. The feedstocks to which the instant application is most applicable to, though, are those that contain at least some sulfur that will be converted to H₂S in the gasifier.

The feedstock of a gasification reactor is reacted with oxygen containing gas, such as air, enriched air, or pure oxygen, and a temperature modifier, such as water or steam, in a gasification reactor to obtain the synthesis gas. The term oxygen containing gas as used herein means air, oxygen-enriched air, i.e. greater than about 21 mole % O₂, and substantially pure oxygen, i.e. greater than about 90% mole oxygen (the remainder usually comprising N₂). The primary function of the oxygen containing gas is used to partially oxidize the carbon in the feedstock into primarily carbon monoxide and hydrogen gas.

The temperature moderator is used to control the temperature in the reaction zone of the gasifier, and is usually dependent on the carbon-to-hydrogen ratios of the feedstock and the oxygen content of the oxidant stream. Water or steam is the preferred temperature moderator. Other temperature moderators include CO₂-rich gas, nitrogen, and recycled synthesis gas. A temperature moderator may be injected into the gasifier in conjunction with liquid hydrocarbon fuels or substantially pure oxygen. Alternatively, the temperature moderator may be introduced into the reaction zone of the gas generator by way of a separate conduit in the feed injector. Together, the oxygen and the temperature modifier can impact the composition of the synthesis gas, but control of the gasification reactor is outside the scope of the present invention.

Partial oxidation reactions utilize a limited amount of oxygen with hydrocarbon feedstocks to produce hydrogen and carbon monoxide (i.e. synthesis gas or syngas), as shown in equation (2) for a straight chain hydrocarbon, instead of water and carbon dioxide as occurs in the case of complete oxidation:

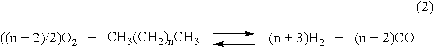

In actuality, this reaction is difficult to carry out as written. There will always be some production of water and carbon dioxide via the water gas shift reaction (3):

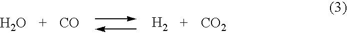

The partial oxidation reaction is conducted under reaction conditions that are sufficient to convert a desired amount of carbon-containing feedstock to synthesis gas or syngas. Reaction temperatures typically range from about 1,700° F. (930° C.) to about 3,000° F. (1650° C.), and more typically in the range of about 2,000° F. (1100° C.) to about 2,800° F. (1540° C.). Pressures can range from about 0 psig (100 kPa) to about 3660 psig (25,000 kPa), but are more typically in the range of about 700 psig (5000 kPa) to about 1500 psig (10,500 kPa).

The synthesis gas, or syngas, product composition will vary depending upon the composition of the feedstock and the reaction conditions. Syngas generally includes CO, H₂, steam, CO₂, H₂S, COS, CH₄, NH₃, N₂, and, if present in the feed to the partial oxidation reactor at high enough concentrations, less readily oxidizable volatile metals, such as lead, zinc, and cadmium. Ash-containing feedstocks frequently produce non-gaseous byproducts that include coarse slag and other materials, such as char, fine carbon particles, and inorganic ash. The coarse slag and inorganic ash are frequently composed of metals such as iron, nickel, sodium, vanadium, potassium, aluminum, calcium, silicon, and the oxides and sulfides of these metals. Much of the finer material is entrained in the syngas product stream.

The coarse slag produced in partial oxidation reactors is commonly removed from the syngas in molten form from the quench section of a gasifier. In the quench section of the gasifier, the synthesis gas product of the gasification reaction is cooled by being passed through a pool of quench water in a quench chamber immediately below the gasifier. Slag is cooled and collects in this quench chamber, from which it and other particulate materials that accumulate in the quench chamber can be discharged from the gasification process by use of a lockhopper or other suitable means. The syngas exiting the quench chamber can be passed through an aqueous scrubber for further removal of particulates before further processing. Quench water is continuously removed and added to the quench chamber so as to maintain a constant level of quench water in the quench chamber of the gasification reactor.

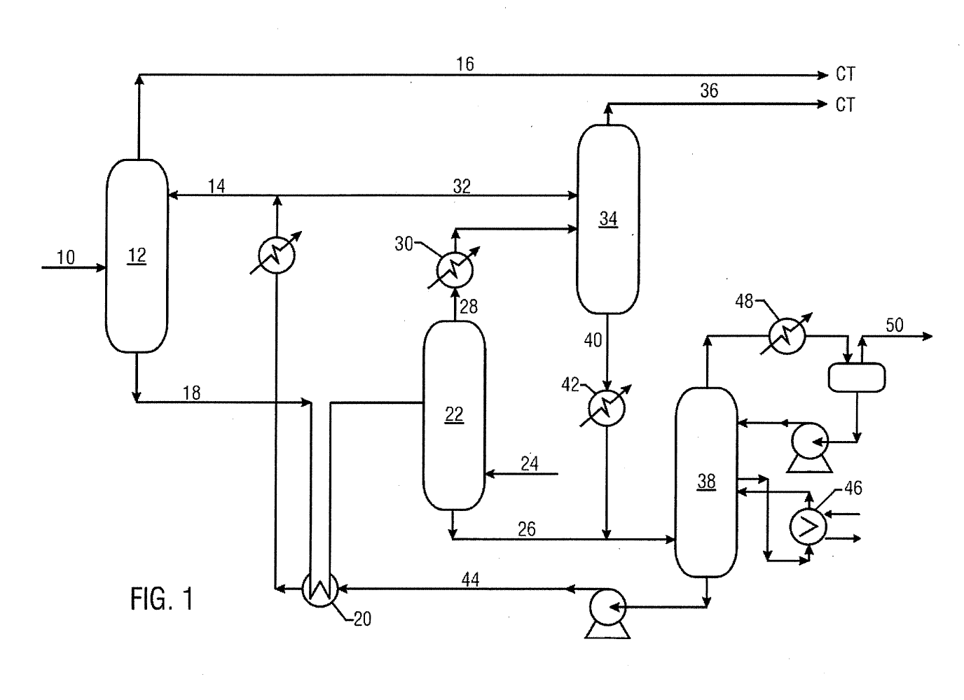

The particulate free synthesis gas may then be treated in a high pressure absorber to remove most of the acid gas components, particularly H₂S and CO₂, thereby producing an acid gas stream and a clean or sweet syngas stream. In the present invention, a chemical solvent such as alkanolamine is used in a unique process configuration (described below with reference to FIG. 1) to not only separate the acid gas from the syngas, but also to separate CO₂ from the acid gas stream. Chemical solvents as described herein include, but are not limited to, various alkanolamine compounds, such as monoethanol amine (MEA), diethanol amine (DEA), diisopropanol amine (DIPA), diglycol amine (DGA), and methyl diethanol amine (MDEA). The resulting CO₂-depleted acid gas stream will be significantly higher in H₂S concentration with a substantial quantity of CO₂ being removed. It is envisioned that the resulting CO₂-rich gas is recovered at minimal pressure loss according to the unique process configuration described below, and can be remixed with the resulting sweet syngas stream as a feed for a gas combustion turbine for power generation.

The resulting sweet syngas can then be expanded to produce power while reducing the pressure of the syngas to about 400 psig (2850 kPa). The syngas mixture entering the expander is preferably heated to a temperature of about 300° F. A large amount of power can be extracted from the expanding volume of the hot syngas, thereby improving the efficiency of the overall power production cycle. Finally, the substantially pure syngas may be sent to, among other things, to a combustion gas turbine for power production.

Referring now to FIG. 1, sour syngas 10 is routed to absorber unit 12. The syngas is contacted with a lean chemical solvent (described in detail above), preferably MDEA, in the absorber unit 12, which may be of any type of absorber technology known to the art, including but not limited to a trayed or a packed column. Operation of such an acid gas removal absorber should be known to one of skill in the art. The sweetened syngas 16 exits the acid gas removal facility at a pressure just slightly less than that of the gasification reactor, about 700 psig (5000 kPa) to about 1500 psig (10,500 kPa). The syngas temperature is typically between about 50° F. (10° C.) to about 210° F. (100° C.), more typically between about 70° F. (20° C.) and about 125° F. (50° C.).

In absorber unit 12, a substantial portion of the H₂S and CO₂ in the syngas is removed, producing the sweet syngas stream 16 and a rich chemical solvent stream 18. Not shown in FIG. 1, the sweet syngas 16 may then be sent to steam heater, where it is heated to about 300° F. using steam. The heated sweet syngas may then be processed in an expander, which turns a shaft that produces power. The syngas product is then at a pressure of about 400 psig, and may then be routed to a gas combustion turbine for further power production.

The rich chemical solvent 18 is then preheated with hot solvent stripper bottoms 44 in lean/rich exchanger 20 and fed to the H₂S concentrator tower 22 where stripping gas 24 is injected to remove CO₂. Any suitable stripping gas 24, including but not limited to nitrogen or steam, may be used to strip the CO₂ from the rich solvent 18. The resulting H₂S concentrator bottoms 26 will be significantly higher in H₂S concentration with a substantial quantity of CO₂ being removed. The resulting H₂S concentrator overhead gas 28 is cooled in exchanger 30 (against cooling water) and is then contacted with lean chemical solvent 32 in reabsorber 34 to remove any flashed H₂S. The reabsorber overhead gas 36 is a CO₂-rich gas and can be remixed with the sweetened syngas 16 prior to feeding a gas combustion turbine (not shown) to increase power production.

The H2S concentrator bottoms 26 is then fed the solvent stripper 38 for final solvent regeneration. In this illustrative embodiment, solvent stripper 38 is operated with a traditional steam reboiler/cooling water condenser (46/48) design, although it is envisioned that any stripping technique is adequate to carry out the present invention. The reabsorber rich solvent 40 is then preheated in exchanger 42 and routed to the solvent stripper 38. Finally, H₂S-rich acid gas 50 may then be routed to further acid gas disposal facilities (not shown), or alternatively, to sulfur recovery facilities (not shown).

The above illustrative embodiment is intended to serve as a simplified schematic diagram of potential embodiments of the present invention. One of ordinary skill in the art of chemical engineering should understand and appreciate that specific details of any particular embodiment may be different and will depend upon the location and needs of the system under consideration. All such layouts, schematic alternatives, and embodiments capable of achieving the present invention are considered to be within the capabilities of a person having skill in the art and thus within the scope of the present invention.

While the apparatus, compounds and methods of this invention have been described in terms of preferred embodiments, it will be apparent to those of skill in the art that variations may be applied to the process described herein without departing from the concept and scope of the invention. All such similar substitutes and modifications apparent to those skilled in the art are deemed to be within the scope and concept of the invention.

What is claimed is:

1. A method for removing H₂S from a sour syngas stream, comprising:
absorbing acid gas from the sour syngas stream using a lean solvent to produce a rich solvent and a sweet syngas stream;
heating the rich solvent to produce a heated rich solvent;
stripping the heated rich solvent with a stripping gas to produce a CO₂-rich gas and a H₂S-rich solvent; and
stripping the H₂S-rich solvent to produce the lean solvent and a H₂S-rich acid gas.

2. The method of claim 1, further comprising mixing the CO₂-rich gas with the sweet syngas stream.

3. The method of claim 1, further comprising cooling the CO₂-rich gas and contacting the cooled CO₂-rich gas with lean solvent to further reduce the H₂S concentration of the CO₂-rich gas.

4. The method of claim 1, wherein the stripping gas comprises nitrogen.

5. The method of claim 1, wherein the lean solvent comprises a chemical solvent.

6. The method of claim 5, wherein the chemical solvent comprises an alkanolamine.

7. The method of claim 6, wherein the chemical solvent comprises methyldiethanolamine.

8. The method of claim 1, wherein the sour syngas stream is produced in a gasification reactor by the partial oxidation of a carbonaceous feedstock.

9. The method of claim 8, wherein the carbonaceous feedstock is selected from the group consisting of pumpable slurries of solid carbonaceous fuels, liquid hydrocarbon fuels, oxygenated hydrocarbonaceous organic materials, and gaseous hydrocarbonaceous fuels.

10. The method of claim 1, wherein the sour syngas stream comprises CO, H₂, CO₂, H₂S, and COS.

11. A method for removing H₂S from a sour syngas stream, comprising:
absorbing acid gas from the sour syngas stream using a lean chemical solvent to produce a rich solvent and a sweet syngas stream;
heating the rich solvent to produce a heated rich solvent;
stripping the heated rich solvent with a stripping gas to produce a CO₂-rich gas and a H₂S-rich solvent;
stripping the H₂S-rich solvent to produce the lean chemical solvent and a H₂S-rich acid gas;
cooling the CO₂-rich gas; and
contacting the cooled CO₂-rich gas with the lean chemical solvent to further reduce the H₂S concentration of the CO₂-rich gas.

12. The method of claim 11, wherein the CO₂-rich gas is mixed with the sweet syngas stream.

13. The method of claim 11, wherein the stripping gas comprises nitrogen.

14. The method of claim 11, wherein the lean chemical solvent comprises an alkanolamine.

15. The method of claim 14, wherein the lean chemical solvent comprises methyldiethanolamine.

16. The method of claim 11, wherein the sour syngas stream is produced in a gasification reactor by the partial oxidation of a carbonaceous feedstock.

17. The method of claim 16, wherein the carbonaceous feedstock is selected from the group consisting of pumpable slurries of solid carbonaceous fuels, liquid hydrocarbon fuels, oxygenated hydrocarbonaceous organic materials, and gaseous hydrocarbonaceous fuels.

18. The method of claim 11, wherein the sour syngas stream comprises CO, H₂, CO₂, H₂S, and COS.

19. A method for producing power, comprising:
partially oxidizing a carbonaceous feedstock in a gasification reactor to produce a sour syngas stream, the sour syngas stream comprising CO, H₂, CO₂, H₂S, and COS;
absorbing acid gas from the sour syngas stream using a lean chemical solvent to produce a rich solvent and a sweet syngas stream;
heating the rich solvent to produce a heated rich solvent;
stripping the heated rich solvent with nitrogen to produce a CO₂-rich gas and a H₂S-rich solvent;
stripping the H₂S-rich solvent to produce the lean chemical solvent and a H₂S-rich acid gas;
cooling the CO₂-rich gas;
contacting the cooled CO₂-rich gas with the lean chemical solvent to further reduce the H₂S concentration of the CO₂-rich gas;
expanding the sweet syngas stream, wherein energy produced by the expansion is used to produce power;
mixing the CO₂-rich gas with the sweet syngas stream to produce a combustion turbine feed; and
combusting the combustion turbine feed in a gas turbine to produce power.

20. The method of claim 19, wherein the lean chemical solvent comprises an alkanolamine.

21. The method of claim 20, wherein the chemical solvent comprises methyldiethanolamine.

22. The method of claim 19, wherein the carbonaceous feedstock is selected from the group consisting of pumpable slurries of solid carbonaceous fuels, liquid hydrocarbon fuels, oxygenated hydrocarbonaceous organic materials, and gaseous hydrocarbonaceous fuels.

23. The method of claim 19, wherein the sour syngas stream comprises CO, H₂, CO₂, H₂S, and COS.
